(19) United States
(12) Patent Application Publication
(10) Pub. No.: US 2024/0181913 A1
(43) Pub. Date: Jun. 6, 2024

(54) Systems and Methods for Detecting an Operational Status of a Charging Connector of an Electric Vehicle Charging System

(71) Applicant: ABB E-mobility B.V., Delft (NL)

(72) Inventors: Miguel Rodríguez Escudé, Schiedam (NL); Lars P. Bech, Schiedam (NL); Stefan J. Raaijmakers, Delft (NL); Gertjan Koolen, Eindhoven (NL); Jimmy van der Heijden, Eindhoven (NL)

(73) Assignee: ABB E-mobility B.V., Delft (NL)

(21) Appl. No.: 18/072,742

(22) Filed: Dec. 1, 2022

(51) Int. Cl. B60L 53/60; B60L 53/16

(52) U.S. Cl. CPC B60L 53/60; B60L 53/16; B60L 2250/10

(57) ABSTRACT

A charging system of an electric vehicle is described. The charging system comprises a charging cable that is adapted to carry a charging connector located at a distal end of the charging cable, wherein the charging connector is configured to be controllably moveable and insertable into an EV charging portal of the EV, the charging connector comprising: a latch coupled to the charging connector, a detection system coupled to the latch, and a control system configured to: obtain, from the detection system, an indication, determine, based on the indication, whether the latch on the charging connector is operational or non-operational, and generate an alert based on determining that the latch on the charging connector is non-operational.

### FIELD

The present disclosure relates to an electric vehicle (EV) charging system.

### BACKGROUND

Some charging connectors of charging cables of EV charging systems may be equipped with a latch mechanism to secure the charging cable of an EV charging system to the electric vehicle. However, this latch is prone to breaking, and if it breaks, it leaves the connection between the charging connector of the charging cable and the electric vehicle insecure. In such a case, a user is able to disconnect the charging connector of the charging cable from the electric vehicle during charging. This causes a hot disconnect of a DC bus in the charging system that may create an arc. Due to the arc, persons standing nearby might get injured, and the charging connector of the charging cable and/or EV inlet could be damaged. The charging connector might also explode due to the expanding gases and high temperature. Traditionally, there is no way to determine whether the latch on the charging connector is intact or damaged. Accordingly, there remains a technical need for system for detecting whether the charging connector of the EV charging system is operational for safe charging of electric vehicles.

### SUMMARY

A first aspect of the present disclosure provides a charging system of an electric vehicle. The charging system comprises: a charging cable that is adapted to carry a charging connector located at a distal end of the charging cable, wherein the charging connector is configured to be controllably moveable and insertable into a EV charging portal of the EV, the charging connector comprising: a latch coupled to the charging connector: a detection system coupled to the latch: and a control system configured to: obtain, from the detection system, an indication: determine, based on the indication, whether the latch on the charging connector is operational or non-operational: and generate an alert based on determining that the latch on the charging connector is non-operational.

According to an implementation of the first aspect, the detection system comprises: a magnetic sensor coupled to a magnet, wherein the magnetic sensor measures a magnetic field associated with the magnet, and wherein the magnet is coupled to the latch.

According to an implementation of the first aspect, obtaining an indication from the detection system further comprises receiving a magnetic field value from the magnetic sensor at the control system.

According to an implementation of the first aspect, determining whether the latch on the charging connector is operational or non-operational further comprises: determining that the latch is non-operational based on the received magnetic field value and a threshold.

According to an implementation of the first aspect, determining that the latch is non-operational comprises: determining a comparison value based on comparing the received magnetic field value to a baseline magnetic field value: and determining that the latch is non-operational based on comparing the comparison value with the threshold.

According to an implementation of the first aspect, the detection system further comprises: a photoelectric sensor coupled to an optic fiber cable, wherein the wherein photoelectric sensor measures optical properties associated with the latch, and wherein the optic fiber is coupled to the latch.

According to an implementation of the first aspect, obtaining an indication from the detection system further comprises receiving optical properties from the photoelectric sensor at the control system.

According to an implementation of the first aspect, determining that the latch on the charging connector is operational or non-operational further comprises: determining that the latch is non-operational based on the received optical properties and threshold.

According to an implementation of the first aspect, determining that the latch is non-operational comprises: determining a comparison value based on comparing the received optical properties to a set of baseline optical properties: and determining that the latch is non-operational based on comparing the comparison value with the threshold.

According to an implementation of the first aspect, the detection system further comprises a wire embedded in the latch.

According to an implementation of the first aspect, obtaining an indication from the detection system further comprises receiving a signal from the wire at the control system.

According to an implementation of the first aspect, determining if the latch on the charging connector is operational or non-operational further comprises: determining the latch is non-operational based on the received signal.

According to an implementation of the first aspect, the alert is a visual alert.

According to an implementation of the first aspect, the alert is an audible alert.

A second aspect of the present disclosure provides a method for determining whether a charging connector of a charging system is operational. The method comprises: obtaining an indication from a detection system coupled to the charging connector, wherein the charging connector is located at a distal end of a charging cable, wherein the charging connector is configured to be controllably moveable and insertable into a EV charging portal of the EV, and wherein the charging connector is coupled to a latch: determining, based on the indication, whether the latch on the charging connector is operational or non-operational: and generating an alert based on determining that the latch on the charging connector is non-operational.

A third aspect of the present disclosure provides a non-transitory computer-readable medium having processor-executable instructions stored thereon, wherein the processor-executable instructions, when executed by one or more controllers, facilitate; obtaining an indication from a detection system coupled to the charging connector, wherein the charging connector is located at a distal end of a charging cable, wherein the charging connector is configured to be controllably moveable and insertable into a EV charging portal of the EV, and wherein the charging connector is coupled to a latch: determining, based on the indication, whether the latch on the charging connector is operational or non-operational; and generating an alert based on determining that the latch on the charging connector is non-operational.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a simplified block diagram depicting an environment for detecting an operational status of a charging connector, according to one or more examples of the present disclosure:

FIG. 2 illustrates a simplified block diagram depicting an EV charging environment, according to one or more examples of the present disclosure:

FIG. 3 illustrates a simplified drawing of a charging connector of an EV charging system, according to one or more examples of the present disclosure:

FIG. 4 is a simplified block diagram of one or more devices or systems within the exemplary EV charging environment of FIG. 2:

FIGS. 5-8 illustrate exemplary detection systems to detect the operational status of a charging connector, according to one or more examples of the present disclosure:

FIG. 9 illustrates a detection system implemented in a charging connecter adapter that is part of the EV charging system: and

FIG. 10 illustrates a process for detecting an operational status of a charging connector of an EV charging system, according to one or more examples of the present disclosure.

### DETAILED DESCRIPTION

The present disclosure describes an electric vehicle (EV) charging system and environment, which provides advantages over the state of the art. In particular, the present disclosure relates to the field of detecting an operational status of a charging connector of an EV charging system. For example, the charging connector of an EV charging system is adapted to connect the charging cable of an EV charging system to an EV inlet in an electric vehicle. Once connected, high voltage electricity flows through the charging cable and charging connector to charge the electric vehicle. In order to ensure safety of the charging process and to avoid damage to the charging connector and electric vehicle, the connection between the charging connector and the EV inlet should be secure. A latch coupled to the charging connector, ensures secure connection of the connector with the EV inlet during the charging process. The latch is part of a retaining means to secure the connection between the charging connector and EV inlet. The latch combines with a locking pin in an EV inlet. The latch can get damaged easily. If the latch is damaged in any way, the locking pin of the EV inlet has no effect in securing the connection by itself. The charging connector of the EV charging system may be easily disconnected from the EV inlet of the electric vehicle while energy is being transferred from the EV charging system to the EV. This may lead to a hot disconnect of the DC bus that may create an arc. In this case, because of the inductance of the system, the current from the EV charging system will not go to 0 instantly when the charging cable disconnects from the EV. There may be a transient current that will travel through the air which may be ionized due to voltage difference created during charging. This creates and maintains an arc. Due to the arc, the charging connector, the charging cable, and EV inlet may be severely damaged. Furthermore, a hot disconnect may cause an explosion of the charging connector or the EV charging system due to expanding gases and high temperature, which may put the electric vehicle and users around the electric vehicle. The present disclosure includes a detection system coupled to a charging connector that is coupled to a charging cable of an EV charging system. The detection system communicates signals to a control system of the EV charging system. The control system of the EV charging system uses the signals to determine whether the latch, coupled to the charging connector of the charging cable is intact or damaged. In the event that the latch is damaged, the EV charging system broadcasts a message to a manager of the charging system stating that the charging connector is damaged, and needs to be repaired.

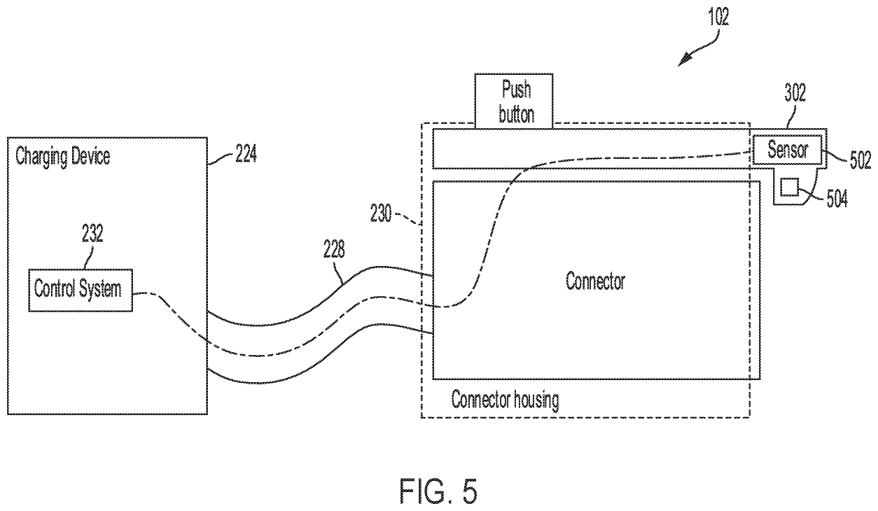

In some embodiments, the detection system may comprise a magnetic sensor coupled with a magnet. The magnetic sensor can be configured to measure a magnetic field associated with the magnet and transmit the measured magnetic field value to a control system of the EV charging system. If the control system of the EV charging system determines a difference in the received magnetic field value compared to a baseline magnetic field value, the control system may transmit a signal to an operator of the charging system that indicates that the charging connector associated with the charging system needs maintenance. The control system may transmit the signal to a back-end server indicating that the charging system requires maintenance. The back-end server may direct that information to an operator of the charging system. In such examples, the baseline magnetic field value may be determined at a time when the magnetic sensor and magnet are installed within the charging connector of the charging cable of the charging system. In such examples, the magnet may be installed within the latch, whereas the magnetic sensor may be installed elsewhere in the charging connector. This is described in greater detail below in connection with FIG. 5.

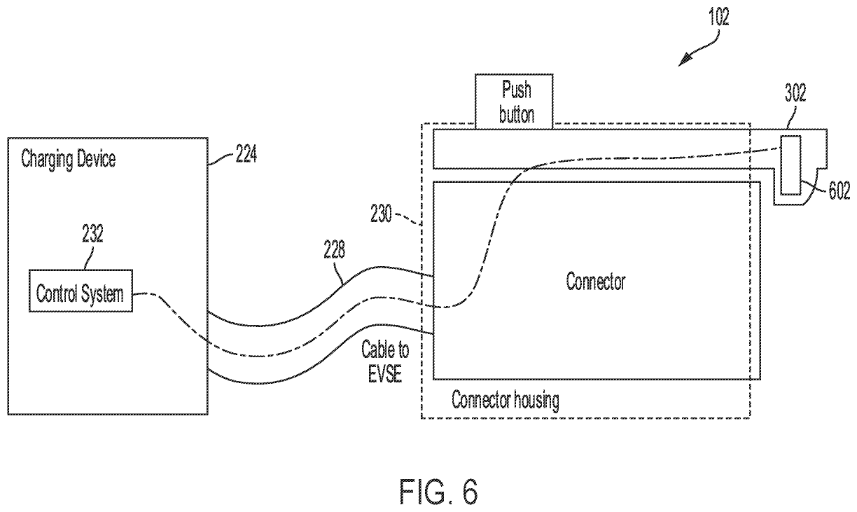

Similarly, a photoelectric sensor coupled to an optic fiber, a wire, or a communication sensor may be coupled to the latch and may be configured to communicate with the control system of the EV charging system. Using the signals received from one or more of these sensors, the control system of the EV charging system may determine whether the charging connector is operational. These embodiments are described in greater detail in connection with FIGS. 6-9.

In particular, exemplary aspects of the charging systems, charging devices, detection systems, and/or back-end servers according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description: however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

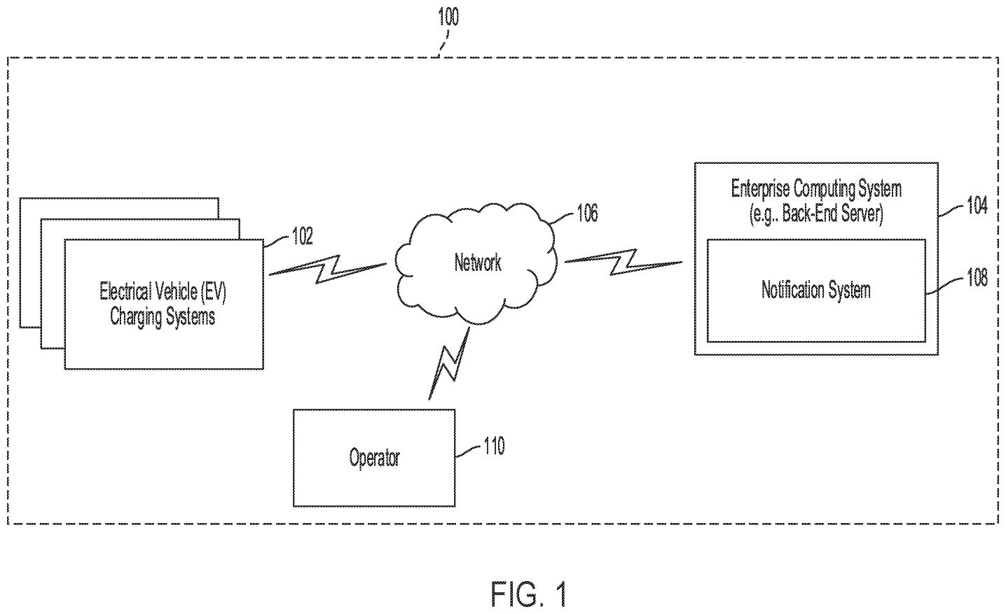

FIG. 1 illustrates a simplified block diagram depicting an environment 100 for detecting an operational status of a charging connector of an electrical vehicle (EV) charging system according to one or more examples of the present disclosure.

Referring to FIG. 1, the environment 100 includes one or more EV charging systems 102 configured to charge an EV, an enterprise computing system 104 (e.g., a back-end server), an operator 110, and a network 106. Although the entities within environment 100 may be described below and/or depicted in the FIGS. as being singular entities, it will be appreciated that the entities and functionalities discussed herein may be implemented by and/or include one or more entities.

The entities within the environment 100 such as the EV charging systems 102, operator 110, and the enterprise computing system 104 may be in communication with other systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. Additionally, and/or alternatively, the EV charging systems 102 and the enterprise computing system 104 may be in communication with each other without using the network 106. For instance, the EV charging systems 102, operator 110, and enterprise computing system 104 may use one or more communication protocols such as WI-FI or BLUETOOTH to communicate with directly with each other.

The enterprise computing system 104 is a computing system that is associated with the enterprise organization. In some instances, the enterprise computing system 104 is a back-end server for the enterprise organization. The enterprise organization may be any type of corporation, company, organization, institution, or the like that is formed to pursue entrepreneurial endeavors such as by selling goods and/or by providing services.

The enterprise computing system 104 includes one or more computing devices, computing platforms, systems, servers, and/or other apparatuses capable of performing tasks, functions, and/or other actions for the enterprise organization. For example, as shown, the enterprise computing system 104 includes a notification system 108. The notification system 108 is responsible for establishing communication between the operator 110 and the EV charging systems 102. The EV charging systems 102 may be located at one physical location or a plurality of physical locations. The notification system 108 may receive notifications from the EV charging systems 102. These notifications may contain information about the status of the EV charging system 102, including details regarding the operational status of the charging connector at each charging system. The notification system 108 may communicate this information regarding the operational status of the charging connector to an operator 110 of the charging system. Finally, the notification system 108, may receive instructions from operator 110 and communicate the instruction to the EV charging system 102.

In some variations, the enterprise computing system 104 may be implemented using one or more computing platforms, devices, servers, and/or apparatuses. In other variations, the enterprise computing system 104 may be implemented as engines, software functions, and/or applications. In other words, the functionalities of the enterprise computing system 104 may be implemented as software instructions stored in storage (e.g., memory) and executed by one or more processors.

One or more of the EV charging systems 102 includes a detection system coupled to a latch of a charging connector of a charging cable, which is configured to secure a connection between the charging cable of the EV charging system 102 and an electric vehicle. The detection system transmits a signal to a control system of the EV charging system 102 which transmits the received signal to enterprise computing system 104. The enterprise computing system 104 may process the received signal and transmit an operational status of the charging connector of the EV charging system 102 to operator 102 via notification system 108.

In some examples, the control system of the EV charging system 102 may process the received signal and transmit an alert directly to operator 110 via network 106. The operator 110 may include a device that is controlled by a human operator. The device may be a mobile device, a computer or any other device capable of connecting to the network 106 to send and receive messages from the enterprise computing system 104 and the EV charging system 102. The operator device 110 may be capable of accessing messages from the EV charging system 102 or the enterprise computing system 104 via a mobile application or a website hosted on the network 106. In such embodiments, the alert transmitted to the operatory may include an alert that is displayed on the device operated by the human operator. The alert may also include an audio alert that is played on the device operated by the operator.

It will be appreciated that the exemplary environment depicted in FIG. 1 is merely an example, and that the principles discussed herein may also be applicable to other environments.

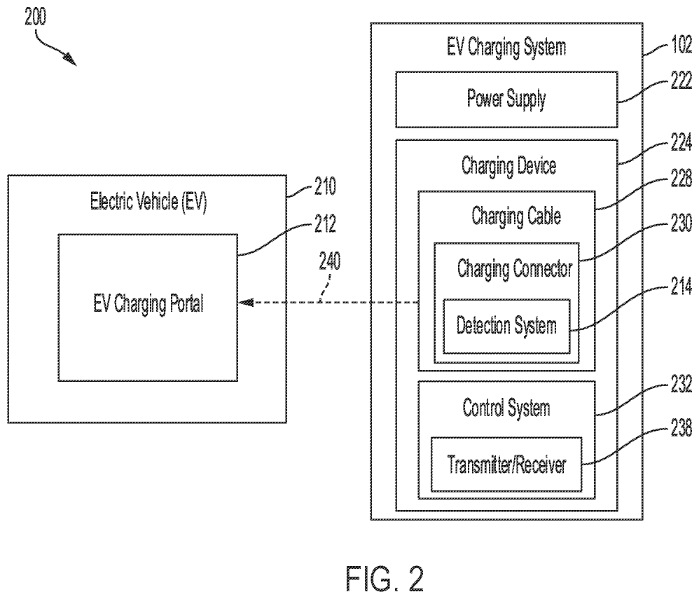

FIG. 2 illustrates a simplified block diagram depicting an EV charging environment 200 according to one or more examples of the present disclosure.

Referring to FIG. 2, the EV charging environment 200 includes an electric vehicle (EV) 210 and an electric vehicle (EV) charging system 102. Among other components, and/or entities, which are not shown, the EV 210 includes an EV charging portal 212 such as an EV inlet that is used to charge the electric vehicle.

The EV charging system 102 includes a charging device 224 and a power supply 222. The charging device 224 includes a charging cable 228, and a control system 232. The charging cable 228 is adapted to engage and carry a charging connector 230. In some instances, the charging connector 230 may be integrated with the charging cable 228, also known as cable assembly.

The power supply 222 may be an EV charging unit (EVCU), which supplies high voltage for charging. The power supply 222 may be usable with or without the charging device 224. The EV charging system 102 is configured to automatically and/or conveniently charge the EV 210, without human intervention or interaction, thus, providing a safe and convenient charging experience for the user or operator of the EV 210.

The power supply 222 receives electric power (e.g., AC or DC power), and converts and conditions the main supply to a power suitable for charging an EV 210 (e.g., a DC voltage with a sufficient current rating for rapid charging of EVs). The power supply 222 is electrically coupled to the charging device 224 to provide charging power to the charging device 224. The charging device 224 may then supply the charging power to the EV 210, in an automated and operator-free manner. A control system 232 of the charging device 224 may communicate with the power supply 222 (e.g., to provide loose or tight control of the charging).

The charging connector 230 is adapted to carry a detection system 214. In some instances, the detection system 214 is installed in the charging connector 230 and is configured to transmit an indication to the control system 232. In such embodiments, the detection system 214 may include a sensor or wire that transmits a signal to the control system 232. A part of the detection system 214 may be embedded within a latch of the charging connector that is used to secure the connection between the charging connector 230 and the EV charging portal 212. In such embodiments, the detection system 214 may be connected to the control system 232 using a wired connection. In some other embodiments, the detection system 214 may be wirelessly connected to the control system 232 using network 106 described in FIG. 1. The layout of the detection system within the charging plug is described in more detail with respect to FIGS. 5-8.

The EV charging system 102 and in particular, the control system 232 may detect an operational status of the charging connector of the charging device 224 using the detection system 214. The control system 232 receives a signal from the detection system 214 of the charging connector 230. The control system 232 processes the received signal to determine an operational status of the charging connector 230. The control system 232 may receive the signal from the detection system 214 via a wired or wireless communication with the transmitter/receiver 238. The signal received from the detection system 214 may include a measurement of an attribute, such as a magnetic field, optical measurements, or electrical continuity or resistance. In such embodiments, the received measurements are compared to a baseline measurement. The baseline measurements may be generated when the detection system 214 is installed in conjunction with the charging connector 230. The baseline measurements also may be measurements that are computed at regular intervals, for e.g., daily, weekly, monthly, etc. The baseline values may be ideal values that are expected to be received from the detection system 214. If the received measurements are greater than or less than the baseline measurements by a particular threshold, the control system 232 determines that the latch of the charging connector 230 is damaged, and in turn determines that the charging cable 228 is not operational anymore. This information is transmitted using transmitter/receiver 238 to an operator 110. The information may also be transmitted in the form of a sound or display alert to a device that is controlled by operator 110.

The control system 232 receives the signal from the detection system 214 and transmits the signal using the transmitter/receiver 238 to the enterprise computing system 104 for processing. In such embodiments, the enterprise computing system 104 may process the signal to determine whether the charging connector 230 is operational. The enterprise computing system 104 then sends a signal to the operator 110, in case the charging connector 230) is determined to be non-operational. The working of the detection system 214 and the control system 232 to determine whether the charging connector 230 is operational is described in more detail with respect to FIGS. 5-8.

It will be appreciated that the exemplary environment depicted in FIG. 2 is merely an example, and that the principles discussed herein may also be applicable to other situations—for example, other types of the EV charging systems 102.

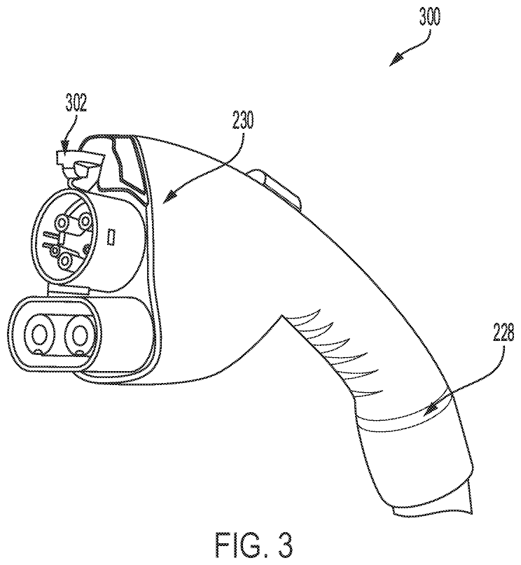

FIG. 3 illustrates a simplified drawing of a charging connector and partial depiction of a charging cable of an EV charging system, according to one or more examples of the present disclosure. As discussed in FIG. 2, the charging cable 228 shown in FIG. 3 is adapted to carry a charging connector 230. In some embodiments, the charging connector 230 may be fully integrated with the charging cable 228, while in other instances, the charging cable 228 may be separate from, but engageable to carry, the charging connector 230. In some examples, the charging connector 230 is inserted into an EV inlet of an EV charging portal 212 of an electric vehicle (not shown). The connection between the charging connector 230 and the EV portal 212 of the electric vehicle is secured using the latch 302. The latch 302 of the charging connector 230) is coupled to a receiving latch receptacle coupled to the EV portal 212. The mechanical connection between the latch 302 and receiving latch receptacle of the EV portal 212 secures the connection between the charging cable 228 and EV portal 212.

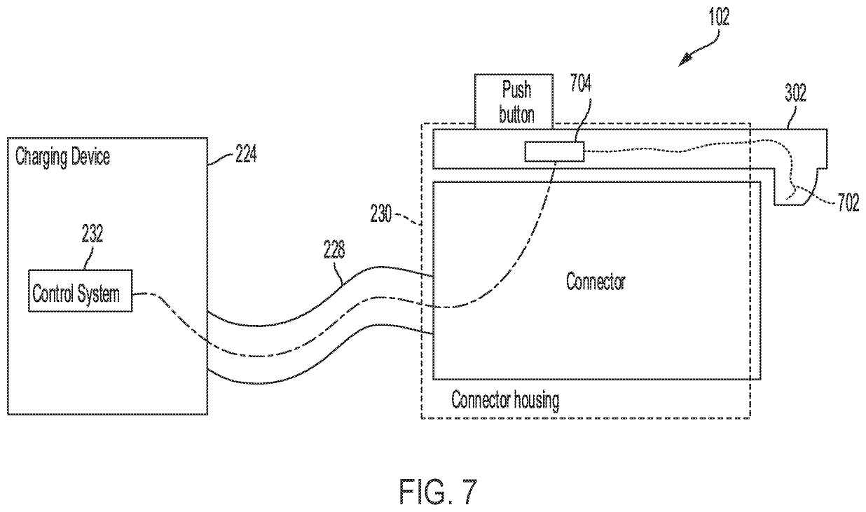

The charging connector 230) is also adapted to carry detection system 214. In some embodiments, the detection system 214 may be fully integrated with the charging connector 230, while in other instances, the charging connector 230 may be separate from, but engageable to carry, the detection system 214. The detection system 214 may consist of multiple parts. For example, the detection system 214 may consist of a sensor and a corresponding field generator. The detection system 214 may include a magnet coupled to a magnetic sensor, or an optical fiber coupled to a photoelectric sensor. Part of the detection system, including a magnet, or optical fiber, may be fully integrated with the latch 302. The magnet or optical fiber may be embedded in latch 302. The magnetic or photoelectric sensor may be coupled to the magnet or optical fiber, but may be located at a different part of charging connector 230. These embodiments are discussed in greater detail in FIGS. 5 and 7.

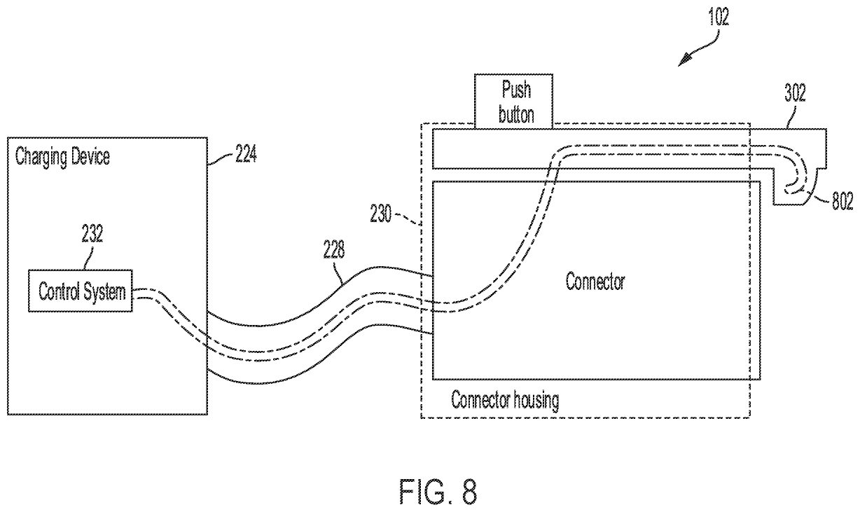

In some embodiments, the detection system may solely be a sensor. In such embodiments, the sensor may be fully integrated with the latch 302. The sensor may be configured to communicate with the control system 232. This embodiment is described in greater detail below with respect to FIG. 6. In other examples, the detection system 214 may be a wire connected to the control system 232 of the EV charging system. In such embodiments, the wire part of the detection system 214 may be integrated with the latch 302. For example, the sensor may be part of the latch 302. A wire from the control system 232 may run through the latch 302. This embodiment is discussed in greater detail below with respect to FIG. 8.

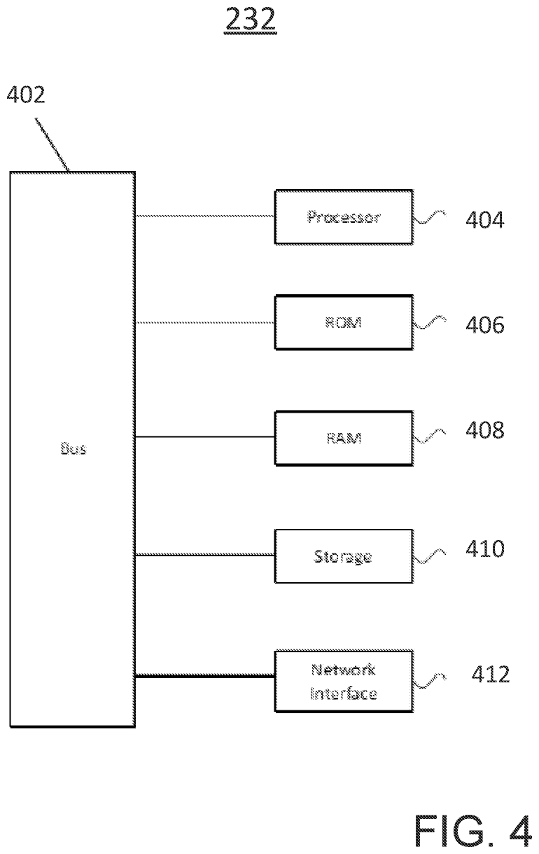

FIG. 4 is a block diagram of an exemplary control system 232 within the EV charging system 102 such as the control system 232. The control system 232 includes a processor 404, such as a central processing unit (CPU), and/or logic, that executes computer executable instructions for performing the functions, processes, and/or methods described herein. The computer executable instructions are locally stored and accessed from a non-transitory computer readable medium, such as storage 410, which may be a hard drive or flash drive. Read Only Memory (ROM) 406 includes computer executable instructions for initializing the processor 404, while the random-access memory (RAM) 408 is the main memory for loading and processing instructions executed by the processor 404. The network interface 412 may connect to a wired network or cellular network and to a local area network or wide area network. The system 400 may also include a bus 402 that connects the processor 404, ROM 406, RAM 408, storage 410, and/or the network interface 412. The components within the system 400 may use the bus 402 to communicate with each other. The components within the system 400 are merely exemplary and might not be inclusive of every component within the control system 232. Additionally, and/or alternatively, the system 400 may further include components that might not be included within every entity of environment 100. For instance, the control system 232 might not include a network interface 412.

FIGS. 5-8 illustrate exemplary detection systems to detect the operational status of a charging connector, according to one or more examples of the present disclosure.

FIG. 5 illustrates a detection system that is part of the EV charging system that includes a magnet and a magnetic sensor. EV charging system depicted in FIG. 5 includes a charging device 224 that includes a control system 232. The charging device 224 is coupled to a charging cable 228, and the charging cable 228 is integrated with a charging connector 230. The charging connector 230 depicts a latch 302 that is used to secure the connection between the charging connector 230 and EV charging portal 212 of an electric car. The detection system 214 is embedded within the charging connector 230. A detection system 214 includes a magnet 504 and magnetic sensor 502. The magnet 504 may be embedded in the latch 302. The magnetic sensor 502 may also be embedded in the latch 302, or may be installed in a different portion of the charging connector 230. The location in which to install the magnetic sensor 502 may be selected based on proximity to the magnet 504. In such embodiments, the magnetic sensor 502 is configured to measure the magnetic field associated with the magnet 504. The magnetic sensor 502 may also be configured to measure the magnetic field continuously. The magnetic sensor 502 may also be configured to measure the magnetic field associated with magnet 504 at regular intervals, such as 2 seconds, 4 seconds, 30 seconds, 60 seconds, 120 seconds etc.

The magnetic sensor 502 may be arranged near the tip of the latch 302 with the magnet 504. In case the latch 302 is separated from the charging connector 230, the magnet 504 will be separated from the latch 302. This may also lead to a drastic change in the position of magnet 504 with respect to magnetic sensor 502. This will create a drastic change in the magnetic field associated with the magnet, which will be transmitted to the control system 232. The control system 232 will interpret this drastic change in magnetic field to be an indication that the latch 302 is damaged, thereby rendering the charging connector 228 of the charging device 224 to be non-operational. Damage to the latch 302 may also cause damage to the magnetic sensor 502, such that magnetic sensor 502 cannot transmit a signal to the control system 232. In case the control system 232 is unable to detect communication from the magnetic sensor 502, the charging connector 230 will be deemed non-operational. Furthermore, damage to the latch 302 may also cause damage to the internal wires of the charging connector 230 that route to the control system 232, which may also lead to determining that the charging connector 230 is non-operational.

The latch 302 may be made up of a metal. In such embodiments, the control system 232 may interpret signals transmitted from the magnetic sensor 502 to determine whether the latch 302 is bent. The control system 232 makes this determination when the control system 232 determines that the received magnetic field from the magnetic sensor 502 is different from a baseline magnetic field by a threshold.

The magnetic sensor 502 may be configured to communicate the measured magnetic field to the control system 232. In such examples, the magnetic sensor 502 may be connected to the control system 232 using a wired connection. Alternatively, the magnetic sensor 502 may be connected to the control system 232 using a wireless connection, such as a Bluetooth. WiFi. or Infrared connection. In such examples, the magnetic sensor 502 may have a transmitter/receiver coupled to the magnetic sensor 502 for their communication with the transmitter/receiver 238 at the control system 232. The magnetic sensor 502 may be configured to transmit the measured magnetic field continuously. Alternatively, the magnetic sensor 502 may be configured to transmit the measured magnetic field as soon as a new measurement is performed by the magnetic sensor. For example, if the magnetic sensor 502 is configured to measure the magnetic field associated with the magnet 504 every 5 seconds, the magnetic sensor may be configured to immediately transmit the measured magnetic field to the control system 232. In some other examples, the magnetic sensor 502 may be configured to transmit the measured magnetic field value at a time different from the time that the magnetic field is measured by the magnetic sensor 502. For example, the magnetic sensor 502 may be configured to measure the magnetic field associated with the magnet 504 ever 4 seconds, but may be configured to transmit the measured magnetic field value every 6 seconds. In such embodiments, the magnetic sensor 502 may be configured to store the measured magnetic field value in a memory associated with the magnetic sensor 502.

In order for the control system 232 to determine whether the charging connector 230 of the charging device 224 is operational, the control system 232 compares the measured magnetic field, received from the magnetic sensor 502 with a baseline value. A baseline value may be calculated at a time when the magnet 504 and the magnetic sensor 502 are installed within the latch and charging connector respectively for the first time. This value is considered the ideal expected value of the magnetic field that indicates that the latch is intact and in ideal functioning condition. In such embodiments, the baseline magnetic field is stored in memory associated with the control system 232. Every measured magnetic field that is received at the control system 232, is compared with the baseline magnetic field, and a difference is computed. If this computed difference between the measured magnetic field value and baseline magnetic field value is greater than a threshold, the control system 232 determines that the latch 302 associated with the charging cable 228 of the charging system 224 is damaged and the latch 302 is not operational. This signal is communicated by transmitter/receiver 238 of the control system 232 to an operator 110 or an enterprise communication system 104 as described in FIG. 1.

In other embodiments, the baseline measurement of the magnetic field may be updated periodically. For example, the control system 232 may be configured to update the baseline magnetic field measurement every 12 hours, or every 24 hours. This may be implemented to ensure that routine movements of the magnet within latch 302 do not unnecessarily trigger a warning. In such embodiments, the baseline magnetic field may be updated with a new baseline magnetic field value, if the difference between the new measured magnetic field and the old baseline magnetic field value is less than a threshold.

The EV charging portal 212 may be magnetic as well. In such embodiments, the magnet of the EV charging portal 212 may influence the magnetic field detected by the magnetic sensor 502. The control system 232 may be configured with a new baseline measurement that may factor in the magnetic components of the EV charging portal 212. In such embodiments, the control system 232 may be configured to store 2 different baseline measurements, one that represents the expected magnetic field when the charging connector 230 is connected to the EV charging portal 212. This baseline measurement may be configured to factor in the increase in magnetic field caused by the magnetic components of the EV portal 212. The second baseline measurement may represent the expected magnetic field when the charging connector 230) is not connected to the EV charging portal 212. In such embodiments, this second baseline magnetic field is lower than the first baseline magnetic field. The control system 232 may also be configured to check both the first baseline value and the second baseline value in order to determine whether charging connector 228 is operational.

The magnetic sensor 502 may also be configured to detect the movement of a metallic pin in the EV charging portal 212 when the charging connector 230 connects with EV charging portal 212.

In some examples, the control system 232 may prompt the magnetic sensor 502 to measure a magnetic field. The control system 232 may be configured to prompt the magnetic sensor 502 synchronously or asynchronously. For example, if the control system 232 is configured to prompt the magnetic sensor synchronously, the control system 232 may poll the magnetic sensor 502 at regular time intervals to measure the magnetic field. Such time intervals may include 1 second, 2 seconds, 3 seconds . . . 60 seconds, 120 seconds, etc. In such examples, the control system 232 may transmit a request to the magnetic sensor 502 via the transmitter/receiver 238 of the control system 232. Upon receiving the message, the magnetic sensor 502 may measure a magnetic field and transmit the measured value back to the control system 232. The measured value may be used by control system 232 to evaluate whether the charging connector 230 is operational.

Alternatively, the control system 232 may prompt the magnetic sensor 502 asynchronously to measure a magnetic field. In such examples, the control system 232 may prompt the magnetic sensor 502 to measure a magnetic field only when the control system 232 deems it to be necessary. For example, the control system 232 may only deem it necessary to compute magnetic field when a user is about to use the charging device 224. In such embodiments, before providing access of the charging device 224 to a user that is requesting it, the control system 232 may transmit a message to the magnetic sensor 232 to measure a magnetic field and use the magnetic field to determine an operational status of the charging connector 230. The control system 232 may also ask the magnetic sensor 502 to measure magnetic field before providing power from the charging device 224 to electric vehicle for charging the electric vehicle. If the magnetic field received at the control system 232 from the magnetic sensor 502 varies from a baseline magnetic field at the control system 232 by more than a threshold, the control system 232 notifies a user at an operating device 110 that the charging connector 230 requires maintenance. In addition, the control system may also enact safety measures such as decommissioning EV charging system 102 or reducing the power provided to EV charging system 102 for charging electric vehicles.

FIG. 6 illustrates a detection system that includes a communication sensor that is part of the EV charging system. The EV charging system depicted in FIG. 6 includes a charging device 224 that includes a control system 232. The charging device 224 is coupled to a charging cable 228, and the charging cable 228 is integrated with a charging connector 230. Charging connector 230 includes a latch 302 that is used to secure the connection between the charging connector 230) and EV charging portal 212 of an electric car. A detection system 214 is embedded within the charging connector 230. The detection system 214 described in FIG. 6 is similar to detection system described in FIG. 5, except that detection system descried in FIG. 6 does not contain a magnet, and the sensor 602 indicated in FIG. 6 is merely a communication sensor.

The communication sensor 602 is configured to communicate with control system 232. The communication sensor 602 may be connected to the control system 232 using a wired connection. Alternatively, the communication sensor 602 may be connected to the control system 232 using a wireless connection, such as a Bluetooth, WiFi, or Infrared connection. The communication sensor 602 may be configured to transmit a message to the control system 232 continuously. Alternatively, the communication sensor 602 may be configured to transmit a message to the control system 232 periodically. In such examples, if the control system 232 does not receive a message from the communication sensor 602, the control system 232 will determine this to be an indication that the latch 302 is damaged, thereby rendering the charging connector 230 of the charging device 224 to be non-operational.

The communication sensor 602 may be configured to communicate with the control system 232 synchronously. For example, if control system 232 is configured to prompt the communication sensor 602 synchronously, the control system 232 may poll the communication sensor 602 at regular time intervals to transmit a message. Such time intervals may include 1 second, 2 second, 3 second . . . 60 seconds, 120 seconds, etc. In such examples, the control system 232 may transmit a request to the communication sensor 602 via the transmitter/receiver 238 of the control system 232. Upon receiving the message, the communication sensor 602 may transmit a message back to the control system 232. If the control system 232 does not receive a message in response of the prompt to communication sensor 602, the control system 232 may determine that the charging connector 230 is non-operational.

In other examples, the control system 232 may asynchronously prompt the communication sensor 602 to transmit a message. In particular, the control system 232 may prompt the communication sensor 602 to transmit a message only when the control system 232 deems it to be necessary. For example, the control system 232 may only deem it necessary to prompt the communication system 602 for a message when a user is about to use the charging device 224. In such embodiments, before providing access of the charging device 224 to a user that is requesting it, the control system 232 may transmit a message to the communication sensor 602 to transmit a message to the control system 232. If the control system 232 does not receive a message from the communication sensor 602, the control system 232 may determine that the charging connector 230 is non-operational. Additionally, the control system 232 may ask the communication sensor 602 to transmit a message before providing power from the charging device 224 to electric vehicle for charging the electric vehicle.

The communication sensor 602 may also be an embedded resistor, so if the resistor is missing or broken the control system 232 may detect it. The communication sensor 602 may also include a strain gauge that when broken or bent will be detected by the control system 232 to determine whether the charging connector 230 is operational.

FIG. 7 illustrates a detection system including a photoelectric sensor that is part of the EV charging system. The EV charging system depicted in FIG. 7 includes a charging device 224 that includes a control system 232. The charging device 224 is coupled to a charging cable 228, and the charging cable 228 is integrated with a charging connector 230. Charging connector 230 includes a latch 302 that is used to secure the connection between the charging connector 230 and EV charging portal 212 of an electric car. A detection system 214 may be embedded within the charging connector 230. The detection system 214 described in FIG. 7 is similar to detection system described in FIG. 5, except that detection system descried in FIG. 7 contains a photoelectric sensor 704 and optical fiber 702.

The optical fiber 702 may be embedded along the latch in 302. In such embodiments, if there is a crack in the latch 302 or the latch 302 is broken, light will hit the fiber optic cable 702 and the optical sensor 704 may transmit a signal to control system 232. Control system 232 may determine from the received signal that the latch 302 is damaged and that charging connector 230 is non-operational. The control system 232 may compare the received signals with a set of baseline optical properties.

A baseline value is calculated at a time when the optical fiber 702 and the photoelectric sensor 704 are installed within the latch and charging connector respectively for the first time. This value is considered the ideal expected value of various optical properties that indicates that the latch is intact and in ideal functioning condition. In some examples, optical properties may include a measure of light or distance. The baseline optical properties are stored in memory associated with the control system 232. In such embodiments, every measured set of optical parameters that are received at the control system 232, is compared with the baseline optical parameters, and a difference is computed. In case this computed difference between the measured optical parameters and baseline optical parameters is greater than a threshold, the control system 232 determines that the latch 302 associated with the charging connector 230 of the charging system 224 is damaged and the latch 302 is not operational. This signal is communicated by the transmitter/receiver 238 of the control system 232 to an operator 110 or an enterprise communication system 104 as described in FIG. 1.

The baseline measurement of the optical parameters may be updated periodically. For example, the control system 232 may be configured to update the baseline optical parameters every 12 hours, or every 24 hours. This may be implemented to ensure that routine movements of the optical fiber 702 within the latch 302 do not unnecessarily trigger a warning. In such embodiments, the baseline optical parameters may be updated with a new baseline optical parameters, if the difference between the new measured magnetic field and the old baseline magnetic field value is less than a threshold.

The optical sensor 704 may be configured to transmit the signal based on the light detected by the optical fiber 702 to the control system 232. The optical sensor may also be configured to synchronously or asynchronously transmit information to the control system 232. The photoelectric sensor 704 may operate similar to the magnetic sensor 502 and the communication sensor 602 as described in FIGS. 5 and 6.

FIG. 8 illustrates a detection system that is part of the EV charging system that includes a wire. EV charging system depicted in FIG. 8 includes a charging device 224 that includes a control system 232. The charging device 224 is coupled to a charging cable 228, and the charging cable 228 is integrated with a charging connector 230. The charging connector 230 depicts a latch 302 that is used to secure the connection between the charging connector 230 and EV charging portal 212 of an electric car. A detection system 214 is embedded within the charging connector 230. The detection system 214 described in FIG. 7 includes a wire 802 embedded in the latch 302.

The wire 802 is directly connected to control system 232. In such embodiments, the wire 802 may start from control system 232 of charging device 224, run through the charging cable 228, the charging connector 230, and reach the latch 302. From latch 302, the same wire 802 runs back to the control system 232 of charging device 224 via the charging cable 228, and the charging connector 230. This complete circuit created by wire 802 that starts and ends at control system 232, may be used to determine whether the latch 302 and the charging connector 230 of the charging device 224 are operational. For example, if the latch 302 is broken or damaged, the wire 802 may be broken or damaged in a corresponding way. The circuit created by the wire 802 may be broken, and the control system 232 may determine from the broken circuit that the latch 302 is damaged. The wire 802 may include a proximity pilot (PP) resistor of the charging device 224 in the charging connector 230. Before beginning a charging process, EV 210 determines whether the PP resistor is part of the circuit. In case PP resistor is not detected, a charging session cannot start. Therefore, if the wire 802 is linked to the PP resistor and the latch is damaged, the wire 802 may be damaged as well. Any damage to wire 802 may cause the PP resistor to be excluded from the circuit, and will not be detected by the EV 210. In such cases, the EV 210 will not start a charging session. The PP resistor is defined in IEC 61851-1 for AC charging and IEC 61851-23 for DC charging. The PP resistor is particular to combined charging system (CCS), but similar resistors are used in other known charging standards that have a “Vehicle Charge Permission” signal/pin.

If the wire 802 is damaged, the PP resistor may be excluded from the charging circuit of charging connector 232. In such embodiments, the charging system 224 does not commence charging of the electric vehicle if the control system 232 determines that the PP resistor is not part of the circuit.

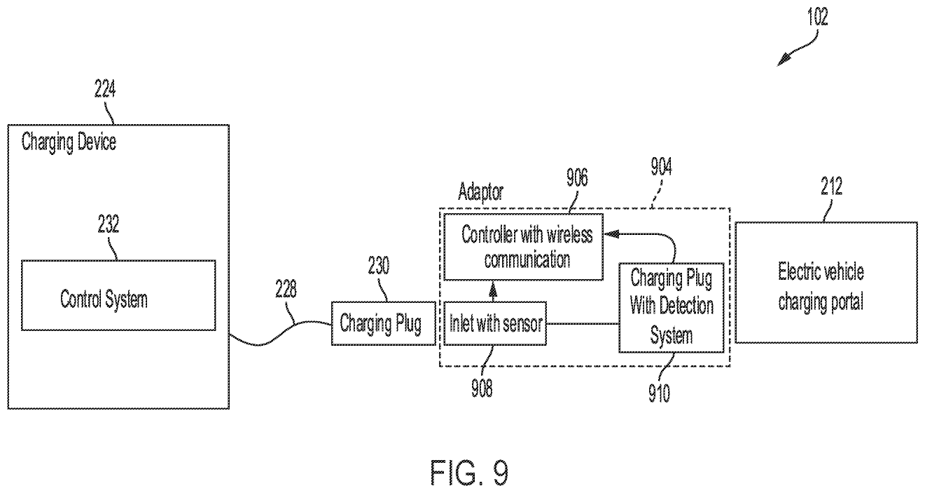

FIG. 9 illustrates a detection system implemented in a charging adapter that is part of the EV charging system. A charging connector 232 and EV charging portal 212 may not be compatible and with each other. For example, the charging connector 230 of EV charging system 102 may be of a first type and the EV charging portal 212 may of a second type that is incompatible to the first type. In such case, a charging adapter may be used to bridge the connection between the charging connector 230 to the EV charging portal 212. FIG. 9 depicts a charging adapter 904 that connects charging connector 230 with the EV charging portal 212. The adapter 904 includes an inlet 908 that is compatible with the charging connector 230. Adapter also includes a charging connector 910 that has a different type from charging connector 230. In such embodiments, the charging connector 910 is compatible with the EV charging portal 212. While charging connector 910 may differ from the charging connector 230 in type, charging connector 910 also has a detection system coupled to charging connector 910. The detection system in charging connector 910 may be similar to the detection system 214. The detection system implemented in the charging connector 910 may not be directly connected with the control system 232 as adapter 232 may not be part of the EV charging system 102. In such embodiments, the adapter 904 includes a controller 906 that may communicate with the control system 232 of charging system 224 of the EV charging system 102. The controller 906 may receive signals from the detection system installed in charging connector 910 and communicate the received signals to the control system 232 before a charge session is initiated. In such examples, the controller 906 may communicate with control system 232 using wireless communication including WiFi, Bluetooth, cellular data (3G/4G/5G), to name a few. The communication between the control system 232 and the charging connector 910 is used to determine whether the adapter is safe to use in conjunction with the charging connector 230 of the charging cable 228. The control system 232 may determine the operational status of the charging connector 230) and the adapter 904 simultaneously to ensure that the entire connection between the charging device 224 and electric vehicle is secure.

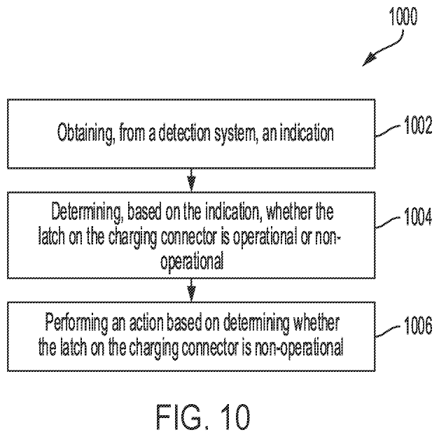

FIG. 10 illustrates an exemplary process for detecting an operational status of a charging connector of an EV charging system, according to one or more examples of the present disclosure. The process 1000 may be performed by the EV charging system 102 of FIG. 1. However, it will be recognized that any of the following blocks may be performed in any suitable order and that the process 1000 may be performed in any environment and by any suitable computing device and/or controller. For instance, the process 1000 may also be performed by the control system 232 shown in FIG. 2.

At block 1002, the control system 232 obtains an indication from a detection system. As described with respect to FIGS. 5-8, a part of a detection system 214 may be embedded within a latch 302 that generates a signal that is transmitted by a corresponding sensor to a control system 232 of an EV charging system 102. For example, the signal may include a magnetic field, optical parameters, communication signals, or current signals.

At block 1004, the control system 232 determines, based on the indication, whether the latch on the charging connector is operational or non-operational. The signal received at control system is analyzed by the control system 230 to determine whether the charging connector is operational or not. Analyzing the signals may include comparing the received signals with a baseline value and determining a difference. This difference is then compared to a threshold to determine if the received signals differs from the baseline value by a threshold. If the control system determines that the received signal differs from the baseline value by more than the threshold, the latch on the charging connector is determined to be non-operational. In some other embodiments, merely receiving or not receiving a signal may constitute determining whether the charging connector is operational. In cases where the control system 232 does not receive a signal from the detection system 214, the control system 214 determines that the latch 302 is damaged and the charging connector is non-operational.

At block 1006, the control system 232 generates an alert based on determining that the latch on the charging connector is non-operational. The control system may transmit an alert to a device that is controlled by an operator of the EV charging system 102. In such embodiments, the device may be programmed to respond to the alert automatically. For example, upon determining that the latch on the charging connector is non-operational, the EV charging system 102 may be suspended from operation until maintenance performed on the latch 302 of the charging connector. In some other examples, the device provides the alert to the operator, and the operator provides instructions to the device on how to handle the alert. These instructions received at the device may be transmitted to controller 232 of EV charging system 102.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Indeed, the application may be exemplified in different forms and should not be construed as limited to the examples set forth herein; rather, these examples are provided so that the application will satisfy applicable legal requirements. Furthermore, when it is said herein that something is “based on” something else, it may be based on one or more other things as well. In other words, unless expressly indicated otherwise, as used herein “based on” means “based at least in part on” or “based at least partially on”.

What is claimed is:

1. A charging system of an electric vehicle, comprising:
a charging cable that is adapted to carry a charging connector located at a distal end of the charging cable, wherein the charging connector is configured to be controllably moveable and insertable into a EV charging portal of the EV, the charging connector comprising:
a latch coupled to the charging connector;
a detection system coupled to the latch; and
a control system configured to:
obtain, from the detection system, an indication;
determine, based on the indication, whether the latch on the charging connector is operational or non-operational; and
generate an alert based on determining that the latch on the charging connector is non-operational.

2. The charging system of claim 1, wherein the detection system comprises:
a magnetic sensor coupled to a magnet, wherein the magnetic sensor measures a magnetic field associated with the magnet, and wherein the magnet is coupled to the latch.

3. The charging system of claim 2, wherein obtaining an indication from the detection system further comprises receiving a magnetic field value from the magnetic sensor at the control system.

4. The charging system of claim 3, wherein determining whether the latch on the charging connector is operational or non-operational further comprises:
determining that the latch is non-operational based on the received magnetic field value and a threshold.

5. The charging system of claim 4, wherein determining that the latch is non-operational comprises:
determining a comparison value based on comparing the received magnetic field value to a baseline magnetic field value; and
determining that the latch is non-operational based on comparing the comparison value with the threshold.

6. The charging system of claim 1, wherein the detection system further comprises:
a photoelectric sensor coupled to an optic fiber cable, wherein the wherein photoelectric sensor measures optical properties associated with the latch, and wherein the optic fiber is coupled to the latch.

7. The charging system of claim 6, wherein obtaining an indication from the detection system further comprises receiving optical properties from the photoelectric sensor at the control system.

8. The charging system of claim 7, wherein determining that the latch on the charging connector is operational or non-operational further comprises:
determining that the latch is non-operational based on the received optical properties and threshold.

9. The charging system of claim 8, wherein determining that the latch is non-operational comprises:
determining a comparison value based on comparing the received optical properties to a set of baseline optical properties; and
determining that the latch is non-operational based on comparing the comparison value with the threshold.

10. The charging system of claim 1, wherein the detection system further comprises a wire embedded in the latch.

11. The charging system of claim 10, wherein obtaining an indication from the detection system further comprises receiving a signal from the wire at the control system.

12. The charging system of claim 11, wherein determining if the latch on the charging connector is operational or non-operational further comprises:
determining the latch is non-operational based on the received signal.

13. The charging system of claim 1, wherein the alert is a visual alert.

14. The charging system of claim 1, wherein the alert is an audible alert.

15. A method for determining whether a charging connector of a charging system is operational, comprising:
obtaining an indication from a detection system coupled to the charging connector, wherein the charging connector is located at a distal end of a charging cable, wherein the charging connector is configured to be controllably moveable and insertable into a EV charging portal of the EV, and wherein the charging connector is coupled to a latch;
determining, based on the indication, whether the latch on the charging connector is operational or non-operational; and
generating an alert based on determining that the latch on the charging connector is non-operational.

16. The method of claim 15, wherein the detection system comprises:
a magnetic sensor coupled to a magnet, wherein the magnetic sensor measures a magnetic field associated with the magnet, and wherein the magnet is coupled to the latch.

17. The method of claim 16, wherein obtaining an indication from the detection system further comprises receiving a magnetic field value from the magnetic sensor.

18. The method of claim 17, wherein determining whether the latch on the charging connector is operational or non-operational further comprises determining that the latch is non-operational based on the received magnetic field value and a threshold.

19. The method of claim 18, wherein determining that the latch is non-operational comprises:
determining a comparison value based on comparing the received magnetic field value to a baseline magnetic field value; and
determining that the latch is non-operational based on comparing the comparison value with the threshold.

20. A non-transitory computer-readable medium having processor-executable instructions stored thereon, wherein the processor-executable instructions, when executed by one or more controllers, facilitate:
obtaining an indication from a detection system coupled to the charging connector, wherein the charging connector is located at a distal end of a charging cable, wherein the charging connector is configured to be controllably moveable and insertable into a EV charging portal of the EV, and wherein the charging connector is coupled to a latch;
determining, based on the indication, whether the latch on the charging connector is operational or non-operational; and
generating an alert based on determining that the latch on the charging connector is non-operational.
